(19) United States
(12) Patent Application Publication
(10) Pub. No.: US 2026/0370585 A1
(43) Pub. Date: Nov. 19, 2026

(54) DETERMINING LATENCY IN A NETWORK NODE

(71) Applicant: Telefonaktiebolaget LM Ericsson (publ), Stockholm (SE)

(72) Inventors: Erik WESTERBERG, ENSKEDE (SE); Sofia SVEDEVALL, BROKIND (SE); Christian SKÄRBY, STOCKHOLM (SE); Johnny KARLSEN, JÄRFÄLLA (SE); Anders K ERIKSSON, UPPSALA (SE)

(73) Assignee: Telefonaktiebolaget LM Ericsson (publ), Stockholm (SE)

(21) Appl. No.: 19/133,891

(22) PCT Filed: Dec. 2, 2022
(86) PCT No.: PCT/EP2022/084275

§ 371 Date: May 29, 2025

(51) Int. Cl. H04L 43/0852

(52) U.S. Cl. CPC H04L 43/0858

(57) ABSTRACT

Methods and apparatus are provided. In an example, a method of determining a latency in a first network node is provided. The method comprises receiving, at a first time instant, a first portion of first data to be sent by the first network node, and determining the latency in the first network node based on a difference between the first time instant and a second time instant by which all of the first data has been sent by the first network node.

### TECHNICAL FIELD

Example embodiments of this disclosure relate to determining latency, such as for example a latency upper bound, in a network node.

### BACKGROUND

A precise and cost-efficient method to measure an upper bound for latency of data transmitted between two reference points is useful for a large set of use cases. While applicable to any information and communication technology (ICT) system, the value of accurately measuring the upper latency bound (also referred to herein as bounded latency) is particularly valuable in a mobile system, such as those specified in 3GPP. This is because the latency in such systems can vary significantly with varying radio conditions and load, and as a result the latency is difficult to predict and control.

By measuring the latency bound in a node or system, it may be possible to understand the quality of experience for end users that are using latency-sensitive applications. These may include for example cloud gaming, real-time video, remote driving of vehicles, augmented reality, virtual reality and more. It may also possible for mobile operators to measure when and where unacceptable latency spikes (e.g. packet latency above a threshold) appear in the network, and under what circumstances it is possible to guarantee good performance for latency-sensitive applications.

In addition, it may be possible with a reliable and accurate method for measuring latency for mobile operators to measure where network capacity expansions are needed, and to measure after the capacity expansion that the objectives for capacity expansions are met.

In some cases, with reliable and accurate measurements of latency, network operators may be able to offer connectivity services with performance guarantees and service-level agreements (SLAs) for connectivity relevant to latency-sensitive applications. This is both a necessary enabler for services that must not fail (such as remote driving) as well as a feature that increases the value of a service compared to a service where no SLAs can be given.

Finally, a reliable and accurate measurement method for the upper latency bound may be useful for automating a mobile network by means of intents. Intent based automation is a promising technology for controlling a system not by means of configuration parameters, but by means of intents that the system shall strive to satisfy. Intent-based automation has successfully been demonstrated in data centers and transport systems, and research is ongoing to understand how to apply intent-based automation to mobile networks. At the core of intent-based operation is the ability to measure the performance of a data flow in terms of bandwidth and bounded latency.

There are currently some methods for measuring the latency for packets through an ICT system. Each method has its merits and drawbacks, and no existing solution can measure the upper latency bound in a data stream with high accuracy at reasonable processing cost. One example comprises measuring the latency of each Protocol Data Unit (PDU) in the system. This method clocks the arrival time of each PDU across the incoming reference point A and clocks the exit time for same packet as it successfully transmitted over reference point B. While this gives an accurate measure of the latency—including average latency, minimum latency, latency jitter and an upper latency bound—it suffers from high cost for processing (every packet needs to be clocked) and scales very poorly with increased data volumes. If the number of PDUs in a stream increases with a factor ×10, for example, then the cost also increases by ×10. This is a major problem for high-bandwidth services such as extended reality and high-resolution real-time video. Moreover, this method is difficult in systems where the two reference points are not part of the same subsystem, and in particular when the two reference points belong to different administrative and/or legal domains. As an example, in a mobile system the first reference point may be in a mobile station, and the second measurement point may be in a network node deployed in a cloud center. In that case, it is not possible to use a single clock that starts/stops as the reference points are in different parts of the network.

In another example, a method similar to that described above is used but only for a subset of the PDUs to get a statistical measure of latency. This method does not suffer from the processing cost drawback of the method described above as the number of packets sampled does not need to grow as the traffic volume grows. However, the sampling has should to be done very frequently to accurately measure the occurrence of rare events, which are often the ones that break a specific latency bound. Therefore, while useful for latency averages and reasonable from a processing cost perspective, this method fails to measure a small percentage of PDUs violating a given latency bound. This method also shares the problem of the method described above in terms of distributed reference points, which is more significant for this method as the two different subsystems must be agree on packet identities and coordinate their random sampling so that it is the same packets that are sampled in both subsystems.

### SUMMARY

Examples of this disclosure may have certain advantages. For example, examples of this disclosure may enable latency or bounded latency in a network node to be determined at a moderate cost in terms of processing and memory. In particular, in some examples, the processing and memory required may not grow with the number of packets in a flow whose latency is being determined, which makes it possible to cost-efficiently monitor latency metrics for latency-sensitive and high-throughput services such as cloud gaming, augmented reality and virtual reality for example.

One aspect of the present disclosure provides a method of determining a latency in a first network node. The method comprises receiving, at a first time instant, a first portion of first data to be sent by the first network node. The method also comprises determining the latency in the first network node based on a difference between the first time instant and a second time instant by which all of the first data has been sent by the first network node.

Another aspect of the present disclosure provides apparatus for determining latency in a first network node. The apparatus comprises a processor and a memory. The memory contains instructions executable by the processor such that the apparatus is operable to receive, at a first time instant, a first portion of first data to be sent by the first network node, and determine the latency in the first network node based on a difference between the first time instant and a second time instant by which all of the first data has been sent by the first network node.

An additional aspect of the present disclosure provides apparatus for determining latency in a first network node. The apparatus is configured to receive, at a first time instant, a first portion of first data to be sent by the first network node, and determine the latency in the first network node based on a difference between the first time instant and a second time instant by which all of the first data has been sent by the first network node.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method of determining a latency in a first network node;

FIG. 2 shows an example of a first network node in which a latency may be determined;

FIG. 3 shows an example of the network node of FIG. 2 including buffered data in a buffer;

FIG. 4 shows an example of PDUs in a process for determining a latency; and

FIG. 5 is a schematic of an example of an apparatus for determining a latency in a first network node.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

Examples of this disclosure may provide solutions for one or more of the above-mentioned problems. In some examples, time is segmented into short time periods (for example, of the order of 5 ms), and then an upper bound for the latency of the set of PDUs that arrived to the system during that period is determined. As explained further below, this may be done for example by measuring once for each period the amount of data that arrived at the system during that period (e.g. was received at the system) and the amount of data exiting the system during same period. Alternatively, for example, the data volume arriving to the system during each period and the volume of data in the system buffer (e.g. at the end of each period) may be measured.

The data measured as suggested above may be used to derive an upper bound of the latency for data (or packets) arriving in each period. The first benefit compared to published technology is that the measurements may be done once every period regardless of the number of packets arriving or data volume. Thus the measurement is cost efficient and the cost is unaffected by the number of packets in the flow or the data volume. As such it is quite affordable to measure the latency bound also for high-bandwidth services such a real time video, cloud gaming and extended reality (XR).

Another benefit of examples of this disclosure is applicability to distributed systems. As long as the two subsystems agree on the measurement periods—which may employ for example a very modest level of time synchronization typically available from the global time known in each system—the traffic volumes can be measured independently and reported to an analytics system that does the calculation. The analytics system may be included in one of the distributed systems or may be separate.

The accuracy of the latency may for example be given by the length of the time period between measurements. The accuracy is typically the twice the time period for example, so if a latency bound of say 100 ms is to be measured then a suitable time-period between measurements can be e.g. 10 ms. The total inaccuracy is thus bounded by 2 times the time period. In this way, the accuracy of latency determined according to examples of this disclosure can be configured in an arbitrary manner at the cost of increased number of measurements in the system.

Thus, examples of this disclosure may provide the advantage that bounded latency in a system or network node can be monitored and assured at a moderate cost in terms of processing and memory. In particular, the processing and memory required does not grow with the number of packets or data volume in a flow, which makes it possible to cost-efficiently monitor bounded latency metrics for high-throughput services such as cloud gaming, augmented reality and virtual reality.

This in turn makes it possible for service providers to accurately monitor the bounded latency for such services for each flow and each user, and to use this information about potential bounded latency breaches to accurately estimate the quality of experience for the service as well as derive service-level agreement (SLA) compliance whenever such is based on bounded latency metrics. This capability may for example form the baseline for a large set of applications including mobile network service assurance, intent-based automation, AI/ML-based radio network algorithms, network planning, network simulations and mobile network tuning and optimization.

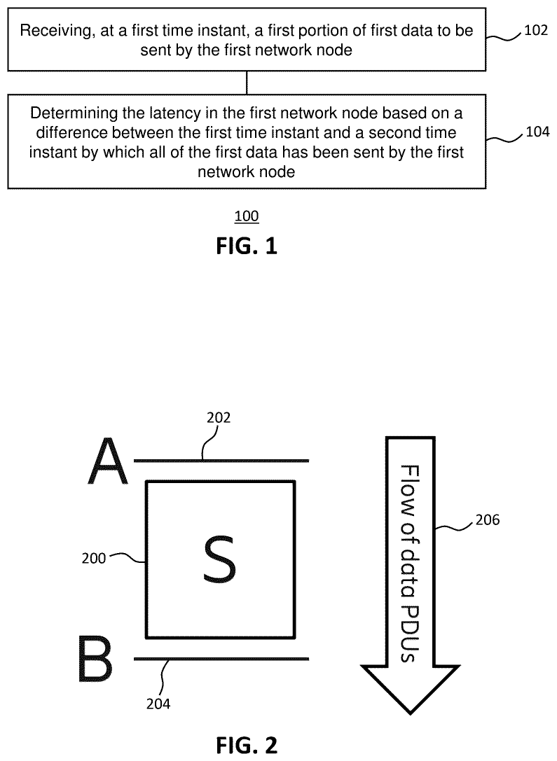

FIG. 1 is a flow chart of an example of a method 100 of determining a latency in a first network node. The first network node may be for example a node in a mobile network, such as for example a User Equipment (UE), base station control unit (CU), base station distributed unit (DU), eNB, gNB, eNB-CU, eNB-DU, gNB-CU, gNB-DU, core network node, router or any other network node. The first network node may also be an O-RAN counterpart to these examples, e.g. O-DU, O-CU etc. Furthermore, in some examples, the latency is determined for a subset of activities in the network node, such as for example the latency for or between one or more particular Open Systems Interconnection (OSI) layers.

In some examples, the latency comprises a latency upper bound in the first network node. The method may in some examples be performed by the first network node.

FIG. 2 shows an example of a first network node 200 in which a latency may be determined in accordance with the method 100 of FIG. 1. The first data may be received at a first interface 202 of the first network node 200 and may be sent from a second interface 204 of the first network node 200. The flow 206 of data PDUs (a non-limiting example of the first data) is shown from the first interface 202 to the second interface 204.

Examples of interfaces include the 3GPP interfaces Uu, F1, N3, S1, and N6. These are the user-plane interfaces where user data flows, and which may be the interfaces in embodiments of this disclosure. However, embodiments of this disclosure may also apply to control-plane interfaces, such as for example the control phase 3GPP interfaces N1, N2, N3 and the O-RAN interfaces A1, O1, and ‘Open Fronthaul interface’.

The method 100 comprises, in step 102, receiving, at a first time instant, a first portion of first data to be sent by the first network node. The data may for example be in the form of one or more packets, PDUs, SDUs or any other data units. The first data may therefore be for example one or more data units such as packets, PDUs or SDUs, and the first portion may be one or more of the data units.

Step 104 of the method 100 comprises determining the latency in the first network node based on a difference between the first time instant and a second time instant by which all of the first data has been sent by the first network node.

In some examples, determining the latency in step 104 comprises determining the latency based on the second time instant by which an amount of buffered data in a buffer of the network node at the first time instant and an amount of the first data has been sent by the first network node since the first time instant. Thus, for example, if at the first time instant (or by the end of a first time period in which the first time instant occurs), the buffer contains buffered data and the first network node has received the first data, then the latency may be determined based on the total of the amount of the first data and the amount of buffered data. That is, for example, once the total amount of data has been sent by the first network node after the first time instant, then the data sent by the first network node is assumed to include the first data and the buffered data at the end of the first time period. By determining the second time instant in which the amount of data sent since the first time instant (or period) equals or exceeds the total, the latency can be determined.

The method 100 may thus in some examples comprise monitoring, in each of a plurality of time periods including a first time period in which the first time instant occurs and a second time period in which the second time instant occurs, an amount of data received by the first network node to be sent by the first network node and the amount of data in the buffer (e.g. at the end of the first time period), wherein the amount of data received in the first time period comprises an amount of the first data.

Determining the latency in the first network node in step 104 may comprise for example determining the latency based on a difference between the first time period and the second time period. This will indicate for example how long it has taken to send the data that was available in the first time period (i.e. the first data and the buffered data). This may comprise for example determining the latency comprises determining the latency based on a number of time periods between the first time period and the second time period. The method 100 may also in some examples comprise determining the second time period by which the amount of buffered data in the buffer at the start of the first time period and the amount of the first data has been sent by the first network node since the start of the first time period. Thus, for example, determining the second time period may comprise determining a second time period by which all of the first data received in the first time period has been sent by the first network node. The plurality of time periods may be consecutive and/or of equal duration in some examples.

Determining the latency based on the difference between the first time period and the second time period may in some examples comprise: determining a time difference between a start of the first time period and an end of the second time period; determining a time difference between a start of the first time period and a start of the second time period; determining a time difference between an end of the first time period and an end of the second time period; or determining a time difference between an end of the first time period and a start of the second time period.

Receiving the first data in step 102 of the method 100 may comprise for example receiving the first data at a first open systems interconnection, OSI, layer in the first network node. The first data may be to be sent to a second layer different to the first layer, and/or may be received from a third layer different to the first layer.

In some examples, the first data is to be sent to a second network node different to the first network node, or an application in the first network node (e.g. data consumed by the application). Additionally or alternatively, receiving the first data may comprise for example receiving the first data from a third network node different to the first network node, or an application in the first network node (e.g. data generated by the application).

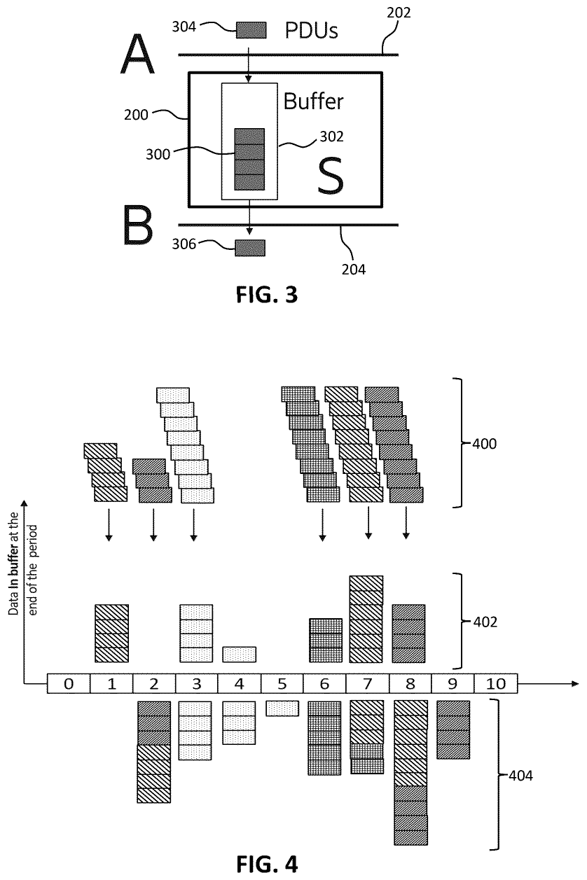

As a specific example, FIG. 3 shows an example of the network node 200 of FIG. 2 including buffered data 300 in a buffer 302. This simple example may represent in a general way various subsystems in a packet data communication system. In one example, the first network node 200 may be a 4G base station in which case the interfaces (or reference points) 202 and 204 may be the 3GPP interfaces S1 and Uu respectively. This may also be the case in an Open Radio Access Network (O-RAN) example. In another example, from a routed fiber network the first network node 200 may be a router, in which case the interfaces (or reference points) 202 and 204 may be the router's network interface connectors (NICs) for incoming and outgoing data flows respectively. Without loss of generality, and to provide a general description of examples of this disclosure, the first network node is represented as a single node 202 including a buffer 302 that holds the first data (e.g. PDUs) from its arrival over reference point 202 to its transmission over reference point 204. However, in other examples, there may be multiple systems and buffers within the first network node 200, such as multiple layers for example. All of these systems and layers may be represented by the single node 200 having one buffer 302 (at least for one flow in some examples).

Starting with an empty buffer—for example, at system start up, or before data in a session starts to flow—the first network node 200 may be configured with the measurement periodicity, ie. the time interval between two consecutive measurements of the buffer status. This time interval may determine the length of the first and second time periods (and other time periods) referred to above in some examples. In this example, the time interval is set to 5 ms. In some examples, the first network node 200 may be given an instruction to start the measurement activity, such as for example from an application or system within the first network node 200 or from another node.

The first network node then measures and records the volume of data in the buffer—measured e.g. in bytes—every 5 ms. For each 5 ms time period, the first network node shall also measure and record the amount of data—measured e.g. in bytes—that was received at the first network node 200 over the interface 202. As time progresses, PDUs 304 may arrive at the first network node 200, and are stored in the buffer 302 until they are successfully sent from the interface 204.

An example of PDUs in this process for determining a latency is illustrated in FIG. 4. In FIG. 4, the horizontal axis represents time periods, which are numbered from 0 to 10, such as for example 5 ms time periods. Each shaded box in FIG. 4 represents a PDU of size 25 bytes, though in other examples they may represent any data units of any size (including in some examples PDUs of different sizes). The upper PDUs 400 represent the data volume that enters the buffer during each time period 0-10. The middle set of PDUs 402 represent the PDUs in the buffer 302 at the end of the time period. The lower set of PDUs 404 represent the PDUs that have been sent by the first network node during the measurement period. Thus, for example, in time period 1, four PDUs are received and these are stored in the buffer, and no PDUs are sent. In time period 2, for example, three PDUs are received and seven are sent, which corresponds to the number of PDUs received in time periods 1 and 2, and thus the buffer is empty by the end of time period 2.

For each measurement period, the amount of data received in the time period (e.g. first data in a first time period), represented by PDUs 400, is determined. Also, either the amount of data (e.g. PDUs 402) in the buffer, or the amount of data (e.g. PDUs 404) sent, in the time period is determined. The amount of data sent in a time period may be determined from the amount of data received and the amount of data in the buffer (plus the amount of data in the buffer from the previous time period, if any). Similarly, the amount of data in the buffer may be determined from the amount of data received in a time period and the amount of data sent in the time period (plus the amount of data in the buffer from the previous time period, if any). For example, the following formula may provide the buffer volume at the end of a time period numbered N:

Buffer volume at end of period N=Buffer volume at end of period N−1+Data volume arriving during period N−Data transmitted in period N).

The following table indicates how much data arrives in each time period and is in the buffer at the end of in each time period in the example shown in FIG. 4:

| Time period | Arriving | In buffer |
|---|---|---|
| 0 | 0 | 0 |
| 1 | 100 bytes | 100 bytes |
| 2 | 75 bytes | 0 |
| 3 | 200 bytes | 100 bytes |
| 4 | 0 | 25 bytes |
| 5 | 0 | 0 |
| 6 | 200 bytes | 75 bytes |
| 7 | 200 bytes | 150 bytes |
| 8 | 200 bytes | 100 bytes |
| 9 | 0 | 0 |
| 10 | 0 | 0 |

Considering time period 7 in FIG. 4 and the above table, the arriving PDUs 400 comprise 8×25 bytes=200 bytes arriving in this time period. There is also a total volume of 6×25 bytes in the buffer at the end of time period 7. As there were 3×25 bytes=75 bytes in the buffer at the end of time period 6 (as indicated in the table), it can be concluded that 5×25 bytes=125 bytes were sent in time period 7.

In other examples, the data sent may be determined instead, according to the following table which is also based on the example of FIG. 4:

| Time period | Arriving | Sent |
|---|---|---|
| 0 | 0 | 0 |
| 1 | 100 bytes | 0 |
| 2 | 75 bytes | 175 bytes |
| 3 | 200 bytes | 100 bytes |
| 4 | 0 | 75 bytes |
| 5 | 0 | 25 bytes |
| 6 | 200 bytes | 125 bytes |
| 7 | 200 bytes | 125 bytes |
| 8 | 200 bytes | 250 bytes |
| 9 | 0 | 100 bytes |
| 10 | 0 | 0 |

The sent data can be derived from the buffered data, and vice versa, as indicated above.

Based on the set of measurements of the influx of data per time period and the volume of data in the system (buffer) at the end of each time period, or the amount of data sent in the time period, in some examples, the upper bound for the latency of the data arriving in each time period may be determined, as follows. The volume of data in the buffer at the start of a time period N is determined, which is given by the volume of data in the buffer at the end of interval N-1. In time period 7 in FIG. 4, this would be 75 bytes (the volume in the buffer at the end of measurement period 6). The volume of data arriving in time period N (also referred to as first data in the methods described above) is added to this. In time period 7, this would be 200 bytes. Under the assumption of in-order delivery of data units, the 75 bytes of data in the front of the buffer from time period 6 will be delivered first, and then the 200 bytes of data that arrived in the interval N, in one or more time periods including the time period N. As long as the system has not transmitted a total of 275 bytes of data—measured from the start of time period N—there are still PDUs in the set of PDUs that arrived in period N that have yet not been transmitted. Furthermore, when the system has delivered 275 bytes of data or more measured from the start of time period N, then all PDUs that arrived in period N that have been transmitted. By monitoring the volumes of data arriving and volumes remaining in the buffer in subsequent time periods following time period N, it can be determined in which time period the accumulated volume of data transmitted from the start of time period N equals or is greater than the sum of the data volume at the start of period N and the volume of data arriving during period N (e.g. 275 bytes in the case of time period 7). If this occurs in time period N+m, we know that the data that arrived in period N has all been transmitted by time period N+m. Therefore, the longest time any of the data arriving in time period N can have spent in the first network node (e.g. in the buffer) is if it entered at the start of time period N and was transmitted at the end of period N+m. This longest time cannot be larger than (m+1) time periods. Thus, the latency upper bound for the first data received in time period N is (m+1) time periods.

Similarly, at least one packet must have been transmitted no sooner than in period N+m and the shortest time that packet could have spent in the system is if it arrived at the end of period N and was transmitted at the start of period N+m. This gives a lower bound of m−1 time periods for any of the data arriving in period N. Thus, all data arriving in period N was sent by the first network node by a second time instant with a time T given by (m−1)<T<(m+1), and m+1 is an upper bound to the latency of any data arriving in period N. In the example in FIG. 4, once again considering time period 7, we derive that a total of 125B was transmitted in period 7, which is less than 275 bytes (75 bytes in buffer at start of period plus 200 bytes arriving in period 7), so that not all packets arriving in period 7 have been transmitted. Determining that 250 bytes were transmitted in period 8, we conclude that by the end of period 8 an accumulated volume of 375 bytes has been transmitted since the start of period 7. As 375 bytes is more than the 275 bytes, all PDUs arriving in period 7 have been transmitted at the end of period 8. Thus, no data arriving in period 7 has spent more than a maximum of two periods (=2×5 ms in this example) before being sent, and the latency is bounded by 10 ms in this example.

Examples of this disclosure may also apply in scenarios where there may be out-of-order delivery. Out-of-order delivery, or retransmissions in the case of 3GPP and O-RAN systems, may add an additional uncertainty to the determined latency. This additional uncertainty may in some examples be bounded in size by the maximum out-of-order delivery (or re-transmission) time. In a particular example, in a 3GPP system, HARQ retransmissions (retransmissions over the radio interface) typically occur with a period of 2-8 ms. The maximum retransmission time is thus the re-transmission period multiplied by the maximum number of re-transmissions. In another example, in a 3GPP 5G system supporting Cloud Gaming services, the retransmission period can be set to 4 ms and the maximum number of re-transmissions can be set to 4. This would mean that a determined latency may have an extra uncertainty of up to 4 ms×4 retransmissions=16 ms. If a better precision is wanted, the maximum number of retransmissions could be set to 2 for example, resulting in an extra uncertainty of up to 4×2=8 ms. In many example applications, the uncertainty from the out-of-order delivery and/or retransmissions may be known or can be accurately measured using existing technology. Also, in many example applications this uncertainty can be smaller than the desired accuracy of the determined latency, and hence embodiments of this disclosure may be used and can provide value even for out-of-order delivery systems.

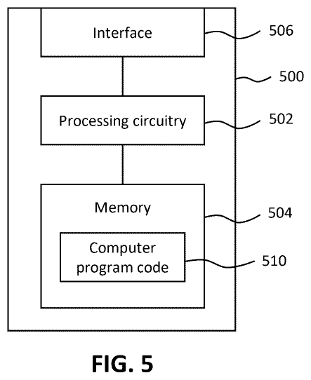

FIG. 5 is a schematic of an example of an apparatus 500 for determining a latency in a first network node. The apparatus 500 comprises processing circuitry 502 (e.g. one or more processors) and a memory 504 in communication with the processing circuitry 502. The memory 504 contains instructions, such as computer program code 510, executable by the processing circuitry 502. The apparatus 500 also comprises an interface 506 in communication with the processing circuitry 502. Although the interface 506, processing circuitry 502 and memory 504 are shown connected in series, these may alternatively be interconnected in any other way, for example via a bus.

In one embodiment, the memory 504 contains instructions executable by the processing circuitry 502 such that the apparatus 500 is operable/configured to receive, at a first time instant, a first portion of first data to be sent by the first network node, and determine the latency in the first network node based on a difference between the first time instant and a second time instant by which all of the first data has been sent by the first network node. In some examples, the apparatus 500 is operable/configured to carry out the method 100 described above with reference to FIG. 1.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method of determining a latency in a first network node, the method comprising:
receiving, at a first time instant, a first portion of first data to be sent by the first network node; and
determining the latency in the first network node based on a difference between the first time instant and a second time instant by which all of the first data has been sent by the first network node.

2. The method of claim 1, wherein determining the latency comprises determining the latency based on the second time instant by which an amount of buffered data in a buffer of the network node at the first time instant and an amount of the first data has been sent by the first network node since the first time instant.

3. The method of claim 2, comprising monitoring, in each of a plurality of time periods including a first time period in which the first time instant occurs and a second time period in which the second time instant occurs, an amount of data received by the first network node to be sent by the first network node and the amount of data in the buffer, wherein the amount of data received in the first time period comprises an amount of the first data.

4. The method of claim 3, wherein determining the latency in the first network node comprises determining the latency based on a difference between the first time period and the second time period.

5. The method of claim 3, comprising determining the second time period by which the amount of buffered data in the buffer at the start of the first time period and the amount of the first data has been sent by the first network node since the start of the first time period.

6. The method of claim 3, wherein the plurality of time periods are consecutive and/or of equal duration.

7. The method of claim 3, wherein determining the latency comprises determining the latency based on a number of time periods between the first time period and the second time period.

8. The method of claim 3, wherein determining the latency based on the difference between the first time period and the second time period comprises:
determining a time difference between a start of the first time period and an end of the second time period;
determining a time difference between a start of the first time period and a start of the second time period;
determining a time difference between an end of the first time period and an end of the second time period; or
determining a time difference between an end of the first time period and a start of the second time period.

9. The method of claim 3, wherein determining the second time period comprises determining a second time period by which all of the first data received in the first time period has been sent by the first network node.

10. The method of claim 1, wherein the first data is received at a first open systems interconnection, OSI, layer in the first network node.

11. The method of claim 10, wherein the first data is to be sent to a second layer different to the first layer.

12. The method of claim 10, wherein receiving the first data comprises receiving the first data from a third layer different to the first layer.

13. The method of claim 1, wherein the first data is to be sent to a second network node different to the first network node, or an application in the first network node.

14. The method of claim 1, wherein receiving the first data comprises receiving the first data from a third network node different to the first network node, or an application in the first network node.

15. The method of claim 1, wherein the latency comprises a latency of one or more open systems interconnection, OSI, layers in the first network node.

16. The method of claim 1, wherein the latency comprises a latency upper bound in the first network node.

17. The method of claim 1, comprising sending the first data.

18. The method of claim 1, wherein the method is performed by the first network node.

19. The method of claim 1, wherein the first network node comprises a User Equipment, UE, base station control unit, CU, base station distributed unit, DU, eNB, gNB, eNB-CU, eNB-DU, gNB-CU, gNB-DU or core network node.

20. Apparatus for determining latency in a first network node, the apparatus comprising a processor and a memory, the memory containing instructions executable by the processor such that the apparatus is operable to:
receive, at a first time instant, a first portion of first data to be sent by the first network node; and
determine the latency in the first network node based on a difference between the first time instant and a second time instant by which all of the first data has been sent by the first network node.

21. The apparatus of claim 20, wherein the memory contains instructions executable by the processor such that the apparatus is operable to determine the latency by determining the latency based on the second time instant by which an amount of buffered data in a buffer of the network node at the first time instant and an amount of the first data has been sent by the first network node since the first time instant.

22. The apparatus of claim 21, wherein the memory contains instructions executable by the processor such that the apparatus is operable to monitor, in each of a plurality of time periods including a first time period in which the first time instant occurs and a second time period in which the second time instant occurs, an amount of data received by the first network node to be sent by the first network node and the amount of data in the buffer, wherein the amount of data received in the first time period comprises an amount of the first data.

23. The apparatus of claim 22, wherein the memory contains instructions executable by the processor such that the apparatus is operable to determine the latency in the first network node by determining the latency based on a difference between the first time period and the second time period.

24. The apparatus of claim 22, wherein the memory contains instructions executable by the processor such that the apparatus is operable to determine the second time period by which the amount of buffered data in the buffer at the start of the first time period and the amount of the first data has been sent by the first network node since the start of the first time period.

25. The apparatus of claim 22, wherein the plurality of time periods are consecutive and/or of equal duration.

26. The apparatus of claim 22, wherein the memory contains instructions executable by the processor such that the apparatus is operable to determine the latency by determining the latency based on a number of time periods between the first time period and the second time period.

27. The apparatus of claim 22, wherein the memory contains instructions executable by the processor such that the apparatus is operable to determine the latency based on the difference between the first time period and the second time period by:
determining a time difference between a start of the first time period and an end of the second time period;
determining a time difference between a start of the first time period and a start of the second time period;
determining a time difference between an end of the first time period and an end of the second time period; or
determining a time difference between an end of the first time period and a start of the second time period.

28. The apparatus of claim 22, wherein the memory contains instructions executable by the processor such that the apparatus is operable to determine the second time period by determining a second time period by which all of the first data received in the first time period has been sent by the first network node.

29. The apparatus of claim 20, wherein the first data is received at a first open systems interconnection, OSI, layer in the first network node.

30. The apparatus of claim 29, wherein the first data is to be sent to a second layer different to the first layer.

31. The apparatus of claim 29, wherein the memory contains instructions executable by the processor such that the apparatus is operable to receive the first data by receiving the first data from a third layer different to the first layer.

32. The apparatus of claim 20, wherein the first data is to be sent to a second network node different to the first network node, or an application in the first network node.

33. The apparatus of claim 20, wherein the memory contains instructions executable by the processor such that the apparatus is operable to receive the first data by receiving the first data from a third network node different to the first network node, or an application in the first network node.

34. The apparatus of claim 20, wherein the latency comprises a latency of one or more open systems interconnection, OSI, layers in the first network node.

35. The apparatus of claim 20, wherein the latency comprises a latency upper bound in the first network node.

36. The apparatus of claim 20, wherein the memory contains instructions executable by the processor such that the apparatus is operable to send the first data.

37. The apparatus of claim 20, wherein the apparatus comprises or is comprised in the first network node.

38. The apparatus of claim 20, wherein the first network node comprises a User Equipment, UE, base station control unit, CU, base station distributed unit, DU, eNB, gNB, eNB-CU, eNB-DU, gNB-CU, gNB-DU or core network node.

39. (canceled)

40. (canceled)
